(19) United States
(12) Patent Application Publication
(10) Pub. No.: US 2002/0078210 A1
(43) Pub. Date: Jun. 20, 2002

(54) Method and system for establishing a communication connection via a schedule store

(76) Inventor: Alexander Aschir, Berlin (DE)

Correspondence Address: BELL, BOYD & LLOYD, LLC, P. O. BOX 1135, CHICAGO, IL, 60690-1135, US

(21) Appl. No.: 09/912,971

(22) Filed: Jul. 25, 2001

(30) Foreign Application Priority Data
Jul. 25, 2000 (DE) 100 36 152.8

(51) Int. Cl. G06F 15/16

(52) U.S. Cl. 709/227; 709/240

(57) ABSTRACT

A method and a system for establishing a communication connection between a person seeking communication and a communication partner to whom a personal communication address is allocated. To provide for a correlation between individual identification codes of communication terminals and the personal communication address in a simple and ergonomic manner, the information about which individual identification code is allocated to the personal communication address of the communication partner at this time is read out of a schedule store of the communication partner, for setting up the communication connection.

### BACKGROUND OF THE INVENTION

1. Field of the Invention

The present invention relates to a method, and system, for establishing a communication connection between a person seeking communication and a communication partner to whom a personal communication address is allocated, in which method, for starting communication, the personal communication address of the communication partner is addressed, an individual identification code of at least one communication terminal is allocated to the personal communication address depending upon day and time, and a communication connection to the at least one communication terminal having the individual identification code is set up.

2. Description of the Prior Art

Such a method is described on the Internet pages having the Internet addresses

htt://www.0700info.de/wwwww.html,

http://www.0700info.de/sp/gr-link.html and

http://www.0700info.de/sp/gr-text.html

(by Niels Diemer). The communication partner provides a correct allocation of the individual identification code to his/her personal communication address even at the beginning of the method by selecting at least one individual identification code in date and time dependence. In this method, the identification code of a communication terminal is, in each case, selected, via which the communication partner can be reached on the respective day and at the respective clock time; e.g., via the landline telephone in the office during working time and via his/her mobile after finishing time. This selection process is also called input of a personal search profile in the above-referenced Internet pages and can take place, for example, via the Internet, a hotline (call center) or a telephone voice menu. If, however, the course of the day of the communication partner deviates from the course of the day forming the basis of the personal search profile input, the individual identification code cannot be correctly allocated to the personal communication address of the communication partner and, in consequence, the desired communication connection cannot be set up.

The present invention is, therefore, directed to a method and an arrangement via which a correlation of individual identification codes of communication terminals with the personal communication address is also made possible in a simple and economic manner if the current course of the day of the communication partner deviates from the course of the day forming the basis of his/her search profile.

### SUMMARY OF THE INVENTION

According to the present invention, this object is achieved in a method of the type initially specified in that, for setting up the communication connection, the information about which individual identification code is allocated to the personal communication address of the communication partner at this time is read out of a schedule store of the communication partner and a communication connection to the communication terminal having this individual identification code is established. In this arrangement, it is particularly advantageous if the information about which individual identification code is to be allocated to the personal communication address of the communication partner at this time is read out of a schedule store of the communication partner in which the time schedules of the communication partner are stored. When these time schedules are known, the probable location of the communication partner is known at the same time so that the individual identification code of a communication terminal which is located at the probable location, or is intended for this location, can be allocated to the personal communication address of the communication partner.

The method according to the present invention can be developed in such a manner that if the information is not available in the schedule store, the individual identification code of the at least one communication terminal is allocated to the personal communication address depending upon time. As a result, a communication connection also can be established if no information (i.e., no time schedule) is entered in the schedule store; to establish the communication connection, an individual identification code is then allocated in dependence on time.

The method according to the present invention can be developed in such a manner that the individual identification codes of a number of communication terminals are allocated to the personal communication address in a preselected order depending upon day and time and if the establishment of the first communication connection fails, the establishment of communication connections to the communication terminals having individual identification codes is attempted in the order of these individual identification codes.

This has the advantage, in particular, that a number of individual identification codes are allocated to the personal communication address of the communication partner so that, if the establishment of the first communication connection to the first individual identification code fails, further attempts can be made to set up communication connections to the individual identification codes of the sequence.

The method according to the present invention can be developed in such a manner that, for setting up the communication connection, the information about which schedule time is provided for the communication partner at this time is read out of a schedule store of the communication partner, at least one individual identification code allocated to the schedule time is read out of an address store of the communication partner, and a communication connection is established to the communication terminal having this individual identification code.

In this arrangement, it is particularly advantageous if, for correlating the individual identification code with the schedule store and the address store, universally usable stores are used which, in many cases, are already set up for the communication partner, and the schedule times of the communication partner are stored in the schedule store and communication addresses used by the communication partner (e.g., telephone numbers or e-mail addresses of persons known to the communication partner) are stored in the address store. The schedule store and the address store do not need to be two physically separate stores. It is also possible for the schedule times and the communication addresses to be stored in a common store.

The method according to the present invention can be developed in such a manner that the schedule store is administered by an appointments book program. In this context, it is particularly advantageous that appointments book programs are often used today (especially by colleagues in companies) for planning schedule dates so that no additional expenditure is required for setting up and using appointments book programs.

The method also can be developed in such a manner that the schedule store is administered by an appointments book program which can be operated via a data processing device of the communication partner. It is particularly advantageous in this context that the appointments book program can be operated directly by the communication partner via the data processing device and no additional operating station is thus necessary for operating the program.

The method according to the present invention also can be developed in such a manner that the appointments book program is operated on a computer which is arranged outside a communication network via which the person seeking communication and the communication partner can be connected. It is particularly advantageous in this context that no access to the communication network is necessary for operating the appointments book program and thus the appointments book program can be operated by service providers which do not operate the communication network.

In the method according to the present invention, the computer and the communication network can be connected via an interface operated in accordance with the specifications of the Parlay Group. The connection of computer and communication network via the interfaces operated in accordance with the specifications of the Parlay Group (also called Parlay gateway) provides a solution for the connection which can be applied in a particularly simple manner since there are Parlay gateways which already can be used. More detailed information on the specifications of the Parlay Group can be obtained at the Internet address www.parlay.org on the Internet.

In the method according to the present invention, a communication network also can be used which has the structure of an intelligent network (IN). A communication network having the structure of an intelligent network is particularly well suited to applying the method according to the present invention since the response of the personal communication address of the communication partner can be detected in a particularly simple manner by such a communication network.

The abovementioned object is also achieved, in accordance with the present invention, by a system for carrying out the method presented above having a schedule store which can be connected to a communication network and in which information is stored about which individual identification codes of communication terminals are allocated to the personal communication address of the communication partner.

The system according to the present invention can be developed in such a manner that schedule times provided for the communication partner are stored in the schedule store and individual identification codes of communication terminals, which can be allocated to the system of schedule times, are stored in an address store.

Additional features and advantages of the present invention are described in, and will be apparent from, the following Detailed Description of the Preferred Embodiments and the Drawings.

### DESCRIPTION OF THE DRAWINGS

FIG. 1 shows a diagrammatic representation of an exemplary embodiment of a view of the schedule times of the communication partner in accordance with the teachings of the present invention; and

FIG. 2 shows a diagrammatic representation of an exemplary embodiment of a system for carrying out the method according to the present invention.

### DETAILED DESCRIPTION OF THE PREFERRED EMBODIMENTS

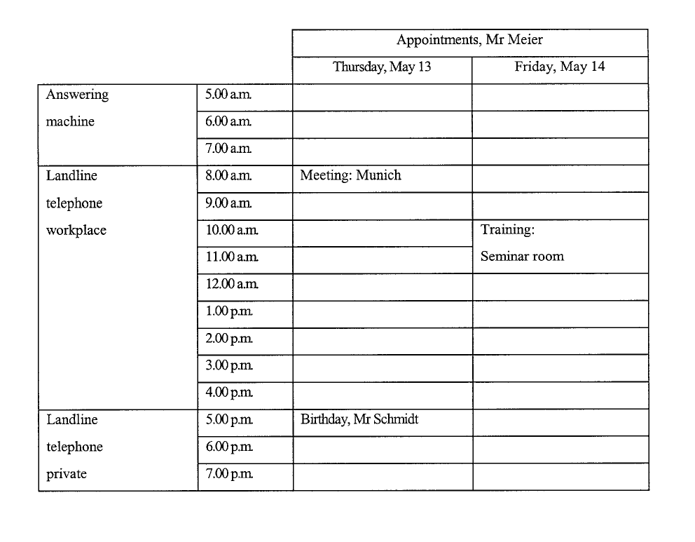

FIG. 1 shows a diagrammatic representation of an exemplary embodiment of a view of the schedule times of the communication partner which can be displayed, for example, on a data processing device via which an appointments book program for administering a schedule store is operated. On the right-hand side of FIG. 1, the days Thursday, May 13 and Friday, May 14 are shown, by way of example, as an excerpt from the appointments book of the communication partner. This is the appointments book of a Mr. Meier who is the communication partner in this example and to whom a communication link is to be set up by addressing his personal communication address. Adjoining the scheduled-time planning for the Thursday on the left hand side, a vertical time axis is shown on which the times from 5 a.m. in the morning to 8 p.m. in the evening are plotted. On the left-hand side of FIG. 1, the preselected destinations are shown to which communication connections are to be set up depending upon the day and the time when the personal communication address of the communication partner is addressed and when there are no schedule times at the relevant time. For example, a communication connection to a communication terminal in the form of an answering machine is to be set up between 5 a.m. and 8 a.m. both on Thursday and on Friday when the personal communication address of the communication partner is addressed. Between 8 a.m. and 5 p.m., a communication connection is to be set up to the communication terminal located at the workplace of the communication partner (in this case, to the landline telephone at the workplace of Mr. Meier) when the personal communication address is addressed, and between 5 p.m. and 8 p.m., the telecommunication connection is to be set up to the private landline telephone in Mr. Meier's private home. These three preselected destinations are always used by default if no schedule times are entered in the right-hand side of FIG. 1. If, however, schedule times are entered on the right-hand side, these schedule times are used in determining the communication terminal to which a communication connection is to be set up.

If the personal communication address of the communication partner Mr. Meier is addressed, for example, on Thursday, May 13 at 8.30 a.m., a communication connection is to be set up to the communication terminal answering machine since the communication partner is in a meeting at this time and does not want to be disturbed. The information that Mr. Meier does not want to be disturbed when a meeting is scheduled and a communication connection is, therefore, to be set up to the answering machine, was entered in the schedule store by Mr. Meier, independently of the actual schedule time. The communication partner can enter various rules, for example, in the schedule store as to how to proceed if there are schedule times.

Examples of rules:

If a meeting is entered in the schedule store, the communication connection is to be set up to the communication terminal answering machine.

If a schedule time of private persons is entered in the schedule store, the communication connection is to be set up to the landline telephone of this private person.

If these private persons cannot be reached via their landline telephone, the communication connection is to be set up to the mobile communication terminal of these private persons (if available).

Such rules can be stored, for example, individually for selected schedule times or globally for all schedule times of the communication partner, for example, in the schedule store.

In accordance with the first abovementioned rule, the individual identification code of the answering machine (in this case, the telephone number of the answering machine) is thus allocated here to the personal communication address and a communication connection to the answering machine is set up. If, however, Mr. Meier's personal communication address is addressed at 8.30 a.m. on Friday, the individual identification code of the communication terminal (in this case his landline telephone) located at Mr. Meier's workplace is allocated to this personal communication address and a communication connection is set up to this landline telephone. This is so because no schedule time is provided at 8.30 a.m. on Friday, and thus the preset destination “landline telephone workplace” (compare left-hand side in FIG. 1) is used for setting up the communication connection.

If, in contrast, the personal communication address of the communication partner is addressed at 5.30 p.m. on Thursday, a schedule time is provided at this time: the communication partner is located at the birthday celebration of Mr. Schmidt and, accordingly, a communication connection is to be set up to a communication terminal which is located at Mr. Schmidt's. Thus, the individual identification code of the landline telephone of Mr. Schmidt is allocated to the personal communication address of Mr. Meier and a communication connection is set up to this landline communication terminal. If no communication connection is established, the individual identification code of the mobile communication terminal of Mr. Schmidt (i.e., the MSISDN of his mobile) is allocated to the personal communication address of Mr. Meier in a second step and a communication connection is established to this mobile communication terminal. The information that, when a schedule time with Mr. Schmidt is arranged, first a communication connection to the landline telephone of the latter and, if a communication connection cannot be successfully set up, then a communication connection to Mr. Schmidt's mobile telephone is set up (compare the abovementioned second and third rules), can again be stored as a rule in the schedule store, independently of the schedule time.

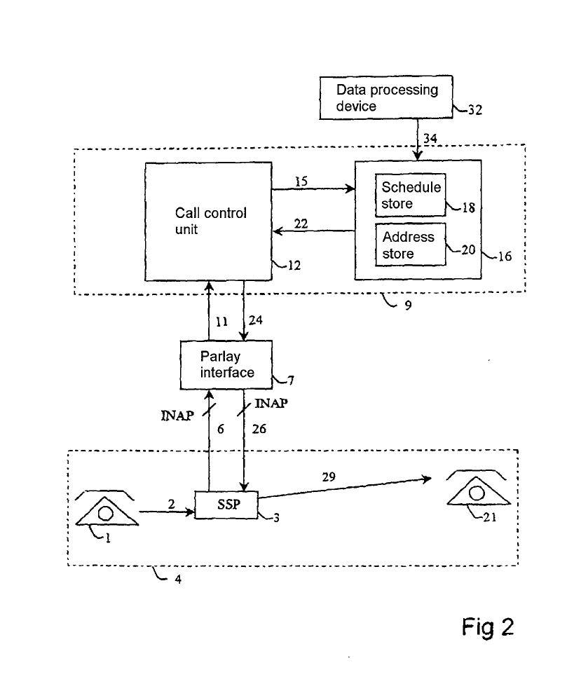

FIG. 2 shows an exemplary embodiment of a system for carrying out the method according to the present invention and, at the same time, an exemplary embodiment of the method according to the present invention. At a communication terminal 1 of a person seeking communication, the personal communication address of a communication partner is addressed for starting communication. Following this, a message 2 is sent to a service switching point 3 of a communication network 4. In this example, the communication network is a telecommunication network. The service switching point 3 (SSP) forms a part of the communication network 4 set up in the structure of an intelligent network (IN). Together with the message 2, the personal communication address of the communication partner is transmitted, among other things, to the service switching point 3. The service switching point 3 detects from the personal communication address that an individual identification code of a communication terminal is to be allocated to this communication address and, therefore, sends a message 6 to an interface operated in accordance with the specifications of the Parlay Group which will be called Parlay interface 7 in the text which follows. Between the service switching point 3 and the Parlay interface 7, messages are transmitted, for example, by using a communication protocol called the Intelligent Network Application Protocol (INAP). The Parlay interface 7 connects the telecommunication network 4 with service provider technology 9 of a service provider which is independent of the operator of the telecommunication network 4. The Parlay interface 7 then sends a message 11 to a call control unit 12 of the service provider technology 9 which thereupon sends another message 15 to a computer 16 of the service provider. This message 15, too, contains the personal communication address of the communication partner, among other things. The computer 16 detects from the message 15 that a telecommunication connection to the communication partner having the personal communication address contained in the message 15 is to be set up and reads out of a schedule store 18 whether a schedule time is provided for this communication partner at the current time. At this point it will be assumed, as an example, that the sample schedule times mentioned in connection with FIG. 1 are stored in the schedule store 18 and that the personal communication address of the communication partner is addressed at 5.30 p.m. on Thursday, May 13. The computer then reads out of the schedule store 18 that a schedule time at Mr. Schmidt's (his birthday) is entered at this time for the communication partner. It is, therefore, known that the communication partner is highly likely to be with Mr. Schmidt. Thus, an individual identification code of a communication terminal of Mr. Schmidt (e.g., the telephone number of his landline telephone 21) is read out of an address store 20. This individual identification code is then sent back to the call control unit 12 via another message 22. The call control unit 12 then requests the Parlay interface 7, by sending a message 24 to it, to set up a communication connection to the communication terminal having this individual identification code. The Parlay interface 7, in turn, translates this request into a message 26 and sends this message, which is structured in accordance with the INAP protocol, to the service switching point 3. Both the message 24 and the message 26 contain the individual identification code of the landline telephone 21 of Mr. Schmidt. The service switching point 3, due to the presence of the individual identification code of the landline telephone 21, is now able to set up a communication connection to this landline telephone 21 of Mr. Schmidt. As a result of the method, a telecommunication connection is thus established between the communication terminal 1 of the person seeking communication and the communication terminal 21 of Mr. Schmidt. The communication terminal 21 of Mr. Schmidt in this case represents the communication terminal via which the communication partner can be reached since the communication partner (in this case, Mr. Meier) has entered a schedule time at Mr. Schmidt's in his schedule store at the current time.

It should be noted at this point that the exemplary embodiment of the method described describes only one possible procedure and only one possible system. For example, the separation between schedule store 18 and the address store 20 in the computer 16 is not absolutely necessary. It is also possible to store in the schedule store 18, together with the schedule times of the communication partner, the individual identification codes of the communication terminals allocated to the respective schedule time which belong to these schedule times; no address store is then required.

The schedule store 18 of the computer 16 is administered by an appointments book program which, in the present example, is also resident in the computer 16. The communication partner can operate this appointments book program via a data processing device 32 which is connected to the computer 16 via a connection 34. This data processing device 32 can be, for example, a computer of the communication partner (e.g., a PC or a portable computer such as a laptop or palmtop) or also a mobile communication terminal such as a mobile. The communication partner enters, for example, his/her schedule times into the schedule store, or updates them, via this data processing device 32. It should be noted, in particular, in this context that the schedule times stored in the schedule store are not necessarily entered or updated only for establishing communication connections via the data processing device 32 of the communication partner. Instead, the data processing device 32, in conjunction with the computer 16, also can be continuously used by the communication partner for storing his/her schedule times in an electronic schedule store, independently of the establishment of communication connections. This frequently makes sense today, especially in companies where colleagues store their schedule times with the aid of a data processing program and these schedule times are to be stored centrally in a schedule store. It is this further possibility of using the schedule times continuously updated by the communication partners in the schedule store, namely the utilization of the schedule times for establishing communication connections, which offers an essential advantage of the method according to the present invention. Since, according to experience, most of the colleagues keep their schedule planning up to date (in this case the schedule planning via data processing device 32 and schedule store 18), no additional administration expenditure arises for establishing communication connections to these colleagues. In addition, the availability of the communication partners is improved since they also can be reached via a communication terminal if (e.g., unique) schedule times are entered in their appointments book.

It is also advantageous that, if certain types of schedule times (such as, e.g., meeting times, compare FIG. 1) are provided, no disturbances, for example, by calls via mobile communication terminals of the communication partner occur because an answering machine, for example, is used as destination for setting up the communication in these cases.

It also should be pointed out again that the abovementioned exemplary embodiment with the computer 16 on which the appointments book program is installed and the data processing device 32 via which the appointments book program can be operated by the communication partner is to be understood only as an example. It is also possible, e.g., to install the appointments book program on the data processing device 32 and only to transmit, and store in the schedule store 18, the schedule times via the connection 34 to the computer 16.

Indeed, although the present invention has been described with reference to specific embodiments, those of skill in the art will recognize that changes may be made thereto without departing from the spirit and scope of the invention as set forth in the hereafter appended claims.

I claim as my invention:

1. A method for establishing a communication connection between a person seeking communication and a communication partner to whom a personal communication address is allocated, the method comprising the steps of:
addressing the personal communication address of the communication partner;
allocating an individual identification code of at least one communication terminal to the personal communication address depending upon time;
reading out of a schedule store of the communication partner information about which individual identification code is allocated to the personal communication address of the communication partner at the time; and
establishing the communication connection to the at least one communication terminal having the individual identification code.

2. A method for establishing a communication connection as claimed in claim 1, wherein, if the information is not available in the schedule store, the individual identification code of the at least one communication terminal is allocated to the personal communication address depending upon time.

3. A method for establishing a communication connection as claimed in claim 1, wherein the individual identification codes of a plurality of communication terminals are allocated to the personal communication address in a preselected order depending upon time and, if the establishment of the first communication connection fails, the establishment of communication connections to the communication terminals having individual identification codes is attempted in the preselected order of the individual identification codes of the plurality of communication terminals.

4. A method for establishing a communication connection as claimed in claim 1, wherein, for setting up the communication connection, the information about which schedule time is provided for the communication partner at the time is read out of the schedule store of the communication partner, at least one individual identification code allocated to the schedule time is read out of an address store of the communication partner, at least one individual identification code allocated to the schedule time is read out of an address store of the communication partner, and a communication connection is established to the communication terminal having the individual identification code allocated to the schedule time.

5. A method for establishing a communication connection as claimed in claim 1, wherein the schedule store is administered by an appointments book program.

6. A method for establishing a communication connection as claimed in claim 1, wherein the schedule store is administered by an appointments book program which can be operated via a data processing device of the communication partner.

7. A method for establishing a communication connection as claimed in claim 5, wherein the appointments book program is operated on a computer which is arranged outside a communication network via which the person seeking communication and the communication partner can be connected.

8. A method for establishing a communication connection as claimed in claim 7, wherein the computer and the communication network are connected via an interface operated in accordance with specifications of a Parlay Group.

9. A method for establishing a communication connected as claimed in claim 7, wherein the communication network is an intelligent network.

10. A system for establishing a communication connection between a person seeking communication and a communication partner to whom a personal communication address is allocated, the system comprising:
at least one communication terminal, wherein, for starting communication, the personal communication address of the communication partner is addressed, and an individual identification code of the at least one communication terminal is allocated to the personal communication address depending upon time; and
a schedule store which can be connected to a communication network via which the person seeking communication and the communication partner can be connected, in which schedule store information is stored about which individual identification codes of a plurality of communication terminals are allocated to the personal communication address of the communication partner, wherein the information is read out of the schedule store and the communication connection to the at least one communication terminal is established.

11. A system for establishing a communication connection as claimed in claim 10, further comprising:
an address store, wherein schedule times of the communication partner are stored in the schedule store, and individual identification codes of communication terminals which can be allocated to the schedule times are stored in the address store.
